(19) United States
(12) Patent Application Publication
(10) Pub. No.: US 2026/0205371 A1
(43) Pub. Date: Jul. 16, 2026

(54) MACHINE-LEARNING BASED ANOMALY DETECTION AND REMEDIATION IN TOPOLOGY IMAGES OF INTERCONNECTED HARDWARE DEVICES

(71) Applicant: Dell Products L.P., Round Rock, TX (US)

(72) Inventors: David M. Hasseler, Cedar Park, TX (US); Wade Baron, Excelsior, MN (US)

(21) Appl. No.: 19/020,637

(22) Filed: Jan. 14, 2025

(51) Int. Cl. H04L 9/40; H04L 41/16

(52) U.S. Cl. CPC H04L 63/1425; H04L 41/16

(57) ABSTRACT

An apparatus in an illustrative embodiment comprises at least one processing device configured to obtain a topology image characterizing a plurality of interconnected hardware devices of information technology infrastructure. The at least one processing device is further configured to apply at least portions of the topology image to a first machine learning model to identify device types for respective ones of the hardware devices of the topology image, to apply at least portions of the topology image to one or more additional machine learning models to identify one or more components of each of the identified device types and to identify one or more anomalies in the topology image based at least in part on the identified components of the identified device types, and to perform one or more automated actions based at least in part on the one or more identified anomalies in the topology image.

### BACKGROUND

Support platforms may be utilized to provide various services for sets of managed hardware devices, such as computers, servers, switches and storage arrays in a data center or other information processing system. Such services may include, for example, troubleshooting and remediation of issues encountered on hardware devices managed by the support platform. This may include periodically collecting information on the state of the managed hardware devices, and using such information for troubleshooting and remediation of the issues. Such troubleshooting and remediation is often carried out responsive to receipt of service requests from users of the hardware devices. However, conventional approaches to such troubleshooting and remediation often require excessive amounts of manual intervention by trained service personnel, potentially leading to substantial delays and increased costs.

### SUMMARY

Illustrative embodiments of the present disclosure provide techniques for machine learning-based anomaly detection and remediation in topology images of interconnected hardware devices. Such hardware devices illustratively include servers, switches, storage arrays and/or other types of information technology (IT) infrastructure, deployed in a data center or other information processing context.

Some embodiments advantageously provide enhanced troubleshooting and remediation, in some cases in a proactive manner prior to receipt of a service request, through use of artificial intelligence (AI) to automatically process topology images of interconnected hardware devices. Such arrangements can eliminate the need for manual intervention, and the excessive delays and costs commonly associated therewith, so as to provide enhanced operational efficiencies in a support platform for a data center or other information processing system.

In one embodiment, an apparatus comprises at least one processing device comprising a processor coupled to a memory. The at least one processing device is configured to obtain a topology image characterizing a plurality of interconnected hardware devices of information technology infrastructure. The at least one processing device is further configured to apply at least portions of the topology image to a first machine learning model to identify device types for respective ones of the hardware devices of the topology image, and to apply at least portions of the topology image to one or more additional machine learning models to identify one or more components of each of the identified device types and to identify one or more anomalies in the topology image based at least in part on the identified components of the identified device types. The at least one processing device is further configured to perform one or more automated actions based at least in part on the one or more identified anomalies in the topology image.

In some embodiments, performing one or more automated actions comprises generating an updated topology image in which the one or more identified anomalies are highlighted and/or corrected.

As another example, performing one or more automated actions in some embodiments comprises generating in a web application a visualization of the topology image in which the one or more identified anomalies are highlighted and/or corrected.

In some embodiments, the first machine learning model is configured to identify a total number of devices of each of the identified device types in the topology image, and is implemented utilizing at least one convolutional neural network (CNN), although a wide variety of other types of machine learning models can be used, as well as combinations of multiple such models. The term “machine learning model” as used herein is therefore intended to be broadly construed, and in some embodiments can comprise a combination of multiple distinct machine learning models of different types.

The one or more additional machine learning models in some embodiments illustratively comprise a second machine learning model configured to identify the one or more components of each of the device types, and a third machine learning model configured to identify the one or more anomalies in the topology image based at least in part on the identified components of the identified device types. Again, numerous other types and arrangements of models can be used in other embodiments. For example, the first and one or more additional machine learning models in some embodiments can comprise separate component machine learning models of a single larger composite machine learning model.

In some embodiments, obtaining the topology image comprises generating the topology image based at least in part on telemetry data provided by remote monitoring equipment associated with the interconnected hardware devices of the information technology infrastructure. Additional or alternative techniques can be used to obtain topology images in other embodiments.

By way of example, identifying one or more anomalies in the topology image based at least in part on the identified components of the identified device types comprises identifying at least one hardware device or component that has a first orientation in the topology image that is different than a second orientation expected based at least in part on telemetry data.

Other anomaly identification examples include identifying at least one hardware device or component that has a bounding box that overlaps with a bounding box of another hardware device or component, identifying a number of detected objects for a particular class of hardware device or component that does not match an expected number of detected objects for the particular class of hardware device or component, and/or identifying a deviation from an interconnection rule relating to pairs of hardware devices or components.

Such features of illustrative embodiments are examples only, and should not be viewed as limiting in any way.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based anomaly detection and remediation in topology images of interconnected hardware devices in an illustrative embodiment.

FIG. 2 is a flow diagram of an example process for machine learning-based anomaly detection and remediation in topology images of interconnected hardware devices in an illustrative embodiment.

FIG. 3 shows an example of a portion of a topology image comprising a server interconnected with a plurality of switches in an illustrative embodiment.

FIGS. 4A through 4C show example pseudocode for configuring and training a machine learning model for recognizing hardware devices of different device types in an illustrative embodiment. These figures are collectively referred to herein as FIG. 4.

FIGS. 5A and 5B show example model parameters and associated performance plots for one possible implementation of a machine learning model for recognizing hardware devices of different device types in an illustrative embodiment. These figures are collectively referred to herein as FIG. 5.

FIGS. 6A through 6G show example pseudocode for utilizing a trained machine learning model to recognize hardware devices of different device types in an illustrative embodiment. These figures are collectively referred to herein as FIG. 6.

FIG. 7 shows an example of a portion of a topology image comprising a server having a plurality of identifiable components including a power supply component identified through machine learning-based processing in an illustrative embodiment.

FIGS. 8A and 8B show example pseudocode for identifying particular components of a given hardware device of an identified device type in an illustrative embodiment. These figures are collectively referred to herein as FIG. 8.

FIGS. 9A through 9D show example pseudocode for identifying anomalies in a topology image using identified components of hardware devices of identified device types in an illustrative embodiment. These figures are collectively referred to herein as FIG. 9.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, switches, storage arrays and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

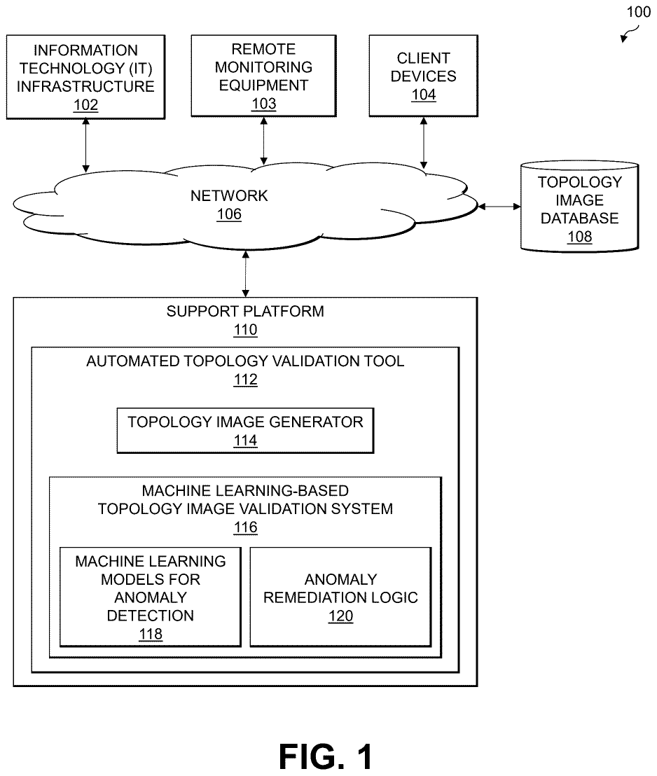

FIG. 1 shows an information processing system 100 configured in accordance with an illustrative embodiment. The information processing system 100 is assumed to be built on at least one processing platform and provides functionality for machine learning-based anomaly detection and remediation in topology images of interconnected hardware devices. The information processing system 100 includes information technology (IT) infrastructure 102, remote monitoring equipment 103 and one or more client devices 104 that are coupled to a network 106. Also coupled to the network 106 is a topology image database 108 and a support platform 110. The support platform 110 in the FIG. 1 embodiment is configured to provide support services for the IT infrastructure 102 and its associated users. Such support services illustratively include detection and remediation of anomalies in topology images generated for at least portions of the IT infrastructure 102, based at least in part on information provided by the remote monitoring equipment 103.

The remote monitoring equipment 103, although shown in the figure as being separate from the IT infrastructure 102, is in some embodiments deployed at least in part within the IT infrastructure 102. For example, the remote monitoring equipment 103 can include various types of sensors or other Internet-of-Things (IoT) devices that are deployed within or in proximity to the IT infrastructure 102. Such sensors and other IoT devices can be configured to report telemetry data as well as other types of data characterizing hardware devices and their interconnections within the IT infrastructure 102. Accordingly, the remote monitoring equipment 103 in some embodiments is remote from the support platform 110, but at least in part co-located with the IT infrastructure 102.

The support platform 110 illustratively comprises an automated topology validation tool 112 that is configured to validate topologies of particular portions of the IT infrastructure 102 based at least in part on the telemetry data and other types of data provided by the remote monitoring equipment 103. Such data may be provided to the support platform in an automated and substantially continuous manner, as the data is gathered by the remote monitoring equipment 103. Additionally or alternatively, such data may be provided in conjunction with a service request sent to the support platform 110 by a system administrator or other user via a corresponding one of the client devices 104.

The automated topology validation tool 112 comprises a topology image generator 114 and a machine learning-based topology image validation system 116. The machine learning-based topology image validation system 116 illustratively comprises a plurality of machine learning models 118 for anomaly detection and further comprises anomaly remediation logic 120 configured to initiate one or more automated actions responsive to detection of anomalies in topology images generated for the IT infrastructure 102. As indicated previously, the term “machine learning model” as used herein is intended to be broadly construed, and in some embodiments can comprise a combination of multiple distinct machine learning models of different types. Accordingly, some embodiments can be configured to utilize a single composite machine learning model that includes multiple distinct component machine learning models, each configured to implement different types of machine learning functionality within the support platform 110.

In some embodiments, the support platform 110 is used for providing support services for one or more enterprises, illustratively including an enterprise operating or otherwise utilizing the IT infrastructure 102. For example, an enterprise may subscribe to or otherwise utilize the support platform 110 to perform automated anomaly detection and remediation for the IT infrastructure 102 or particular designated portions thereof. The anomaly detection and remediation can be performed, for example, on a proactive basis and/or in response to one or more service requests made by administrators or other users within the enterprise. The support platform 110 in some embodiments may be operated by or on behalf of a manufacturer and/or vendor of at least portions of the IT infrastructure 102, so as to provide support services for corresponding interconnected hardware devices of the IT infrastructure 102. For example, such a manufacturer and/or vendor can provide the support platform 110 for use by its customers, to facilitate their operation and management of the IT infrastructure 102.

The IT infrastructure 102 can comprise, for example, at least one data center, cloud-based system or other arrangement of multiple interconnected hardware devices, where the term “hardware device” as used herein is intended to be broadly construed so as to encompass, for example, computers, servers, switches, storage arrays and/or other processing devices that may be interconnected with one another within a given information processing system. Such hardware devices illustratively comprise various arrangements of processing devices that execute software programs stored in associated memory in order to implement at least portions of the functionality of that hardware device.

The client devices 104 may comprise, for example, physical computing devices such as mobile telephones, laptop computers, tablet computers, desktop computers or other types of processing devices, in any combination, that may be utilized by members of an enterprise or other users operating or otherwise associated with the IT infrastructure 102. At least portions of the client devices 104 may be implemented utilizing virtualized computing resources, such as virtual machines (VMs), containers, etc. Also, although shown as separate from the IT infrastructure 102 in the figure, at least a portion of the client devices 104 may be implemented within the IT infrastructure 102 in other embodiments.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The topology image database 108 is configured to store information that is used by the automated topology validation tool 112 for performing anomaly detection and remediation in the support platform 110. This information illustratively comprises topology images generated by the topology image generator 114, which may be generated at least in part utilizing data characterizing interconnected hardware devices of the IT infrastructure 102 as supplied by the remote monitoring equipment 103. The associated data from which the topology images are generated may also be stored in the topology image database 108. The topology images and associated data stored in the topology image database are illustratively used in training the machine learning models 118. Additional topology images received from other sources can similarly be used in training the machine learning models 118.

In some embodiments, at least portions of such topology images may be generated by the topology image generator 114 utilizing the techniques disclosed in U.S. Pat. No. 10,027,555, issued Jul. 17, 2018 and entitled “Visual Diagramming Tool for Hardware Configurations,” which is hereby incorporated by reference herein in its entirety. Other types of techniques can be used to generate topology images for processing in the system 100, as will be appreciated by those skilled in the art.

The topology image database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

In some embodiments, such storage systems utilized to implement the topology image database 108 can be considered part of the IT infrastructure 102. Alternatively, although shown as separate from support platform 110 in the figure, the topology image database 108 and its associated storage system can in some embodiments be implemented at least in part within the support platform 110.

The support platform 110 in some embodiments implements generative AI and other machine learning techniques for automated validation of topology images. Such topology images in some embodiments illustratively comprise customer data center topology diagrams generated for respective portions of the IT infrastructure 102 utilizing the topology image generator 114 of the support platform 110 or another topology image generator located elsewhere within the system, such as in the IT infrastructure 102 or its associated remote monitoring equipment 103. In some embodiments, the validation includes verification of the accuracy of the image rendering compared to its underlying telemetry data as well as a “best practices” review of the associated connectivity between hardware devices. Such validation can advantageously ensure that the topology images representing customer data center assets and their interconnections are rendered accurately, completely and in a manner that facilitates optimum performance relative to recommended best practices.

In some embodiments, data center topology diagrams or other types of topology images are produced and rendered on demand in the topology image generator 114 of the support platform 110. For example, such topology images can be generated in a console services support application that implements the automated topology validation tool 112. A given such topology image can be generated, for example, based at least in part on a received asset service tag, utilizing corresponding telemetry data from the remote monitoring equipment 103 for the time period of interest. It is important that the resulting topology images accurately represent the physical reality of how the assets are deployed and interconnected in the customer data center in order to provide the highest quality customer support.

Telemetry data from which such topology images are generated in some embodiments can be inherently unpredictable, occasionally incomplete, and may be lacking a solidly standardized schema. These and other issues can result in certain elements in a given topology image being rendered incorrectly or otherwise misrepresented.

Since hundreds if not thousands of such topology images could be produced daily for a wide range of products deployed in the IT infrastructure 102, it is highly impractical, as well as cost prohibitive, to manually review and validate the topology images produced from the telemetry data.

Illustrative embodiments disclosed herein provide technical solutions to the above-noted problems, by providing machine learning-based anomaly detection and remediation in topology images of interconnected hardware devices. For example, through the use of generative AI and other machine learning techniques implemented in automated topology validation tool 112, topology images that are generated in the support platform 110 can be automatically verified in real time, with associated reporting on any errors, discrepancies or other variances from best practices in the connectivity of the corresponding IT assets in a data center or other IT infrastructure context.

Such results can be used to control modification of the physical deployment of IT assets in the data center in order to achieve an optimal deployment that is in accordance with best practices. These results in some embodiments can additionally or alternatively be used to modify the manner in which the topology images are generated by the topology image generator 114. Numerous other automated actions can be performed in other embodiments as part of the remediation of identified anomalies in topology images.

Accordingly, some embodiments disclosed herein therefore allow topology images characterizing interconnected hardware devices of a data center or other instantiation of IT infrastructure 102 to be automatically validated in the automated topology validation tool 112, including associated remediation to meet best practices or other specified standards, without any need for human intervention and its associated delays and costs.

These embodiments can therefore not only improve the operation of a data center or other instantiation of the IT infrastructure 102, by automatically detecting and remediating deviations from best practices, but can also enhance the process of generating topology images in this and numerous other contexts.

In operation, the automated topology validation tool 112 of the support platform 110 is configured to obtain a topology image, illustratively from the topology image generator 114, characterizing a plurality of interconnected hardware devices of the IT infrastructure 102. For example, in some embodiments, the topology image is generated within the support platform 110 by the topology image generator 114 based at least in part on telemetry data and/or other types of data obtained in the support platform 110 from the remote monitoring equipment 103 associated with the IT infrastructure 102. Such telemetry data and/or other types of underlying data utilized in generating the topology image can in some embodiments be in the form of JavaScript Object Notation (JSON) data, although numerous other data formats can be used.

A given topology image can be obtained in other ways, such as retrieved from the topology image database 108 or retrieved from another external source accessible to the support platform 110 over the network 106. As another example, in some embodiments, a topology image can be obtained in the support platform 110 from a given one of the client devices 104. In such an arrangement, the topology image can comprise an image generated by a topology image generator of the given client device.

The term “topology image” as used herein is therefore intended to be broadly construed, so as to encompass any of a wide variety of images that characterize interconnected hardware devices of the IT infrastructure 102, including topology drawings or other topology images that are automatically generated in a topology image generator such as topology image generator 114 based at least in part on telemetry data and/or other underlying data provided by remote monitoring equipment 103 and/or other data sources.

The automated topology validation tool 112 of the support platform 110 is further configured to apply at least portions of the obtained topology image to a first machine learning model of the machine learning models 118 to identify device types for respective ones of the hardware devices of the topology image. The first machine learning model in some embodiments is more particularly configured to identify a total number of devices of each of the identified device types in the topology image.

The automated topology validation tool 112 of the support platform 110 is still further configured to apply at least portions of the obtained topology image to one or more additional machine learning models of the machine learning models 118 to identify one or more components of each of the identified device types and to identify one or more anomalies in the topology image based at least in part on the identified components of the identified device types. For example, in some embodiments, the one or more additional machine learning models comprise a second machine learning model configured to identify the one or more components of each of the device types, and a third machine learning model configured to identify the one or more anomalies in the topology image based at least in part on the identified components of the identified device types. Other arrangements of machine learning models 118 of the machine learning-based topology image validation system 116 can be used in other embodiments.

The automated topology validation tool 112 is also configured to perform one or more automated actions based at least in part on the one or more identified anomalies in the topology image. Such automated actions are illustratively initiated, triggered or otherwise controlled by the anomaly remediation logic 120 of the machine learning-based topology image validation system 116. For example, in some embodiments, the one or more automated actions controlled by the anomaly remediation logic 120 comprise generating an updated topology image in which the one or more identified anomalies are highlighted and/or corrected. Additionally or alternatively, the one or more automated actions controlled by the anomaly remediation logic 120 comprise generating in a web application a visualization of the topology image in which the one or more identified anomalies are highlighted and/or corrected. Such a web application is illustratively accessible to an authorized user associated with one of the client devices 104. A wide variety of other types of automated actions can be performed in other embodiments.

At least some of the machine learning models 118 illustratively comprise generative AI models. Such generative AI models can be configured, for example, to generate outputs describing aspects of one or more identified anomalies and/or associated remediation actions to be taken based on those identified anomalies.

The support platform 110 in the FIG. 1 embodiment is assumed to be implemented using at least one processing device. Such processing devices can illustratively include particular arrangements of computing, storage and network resources. Each such processing device generally comprises at least one processor and an associated memory, and implements at least portions of one or more functional modules or other logic for controlling certain features of the support platform 110 as disclosed herein.

Accordingly, at least portions of the automated topology validation tool 112 of the support platform 110 may be implemented at least in part in the form of software that is stored in at least one memory and executed by at least one processor.

The support platform 110 and other portions of the information processing system 100 may be implemented using at least one processing platform comprising one or more processing devices each having a processor coupled to a memory. Such a processing platform can be implemented in cloud infrastructure or as part of an enterprise system.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the IT infrastructure 102, the remote monitoring equipment 103, the client devices 104, the topology image database 108 and the support platform 110, or portions or components thereof, to reside in different data centers in different geographic locations. Numerous other distributed implementations are possible. The support platform 110 itself can also be implemented in a distributed manner across multiple data centers.

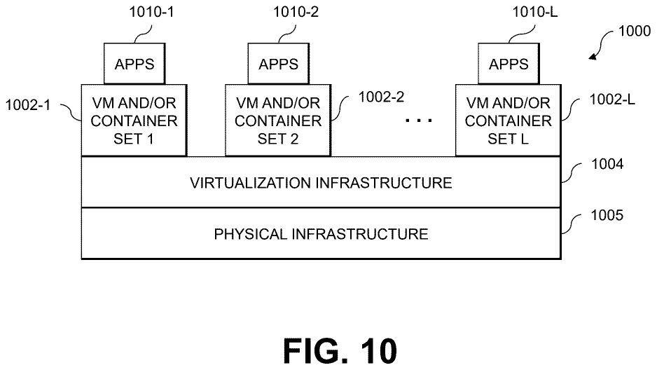

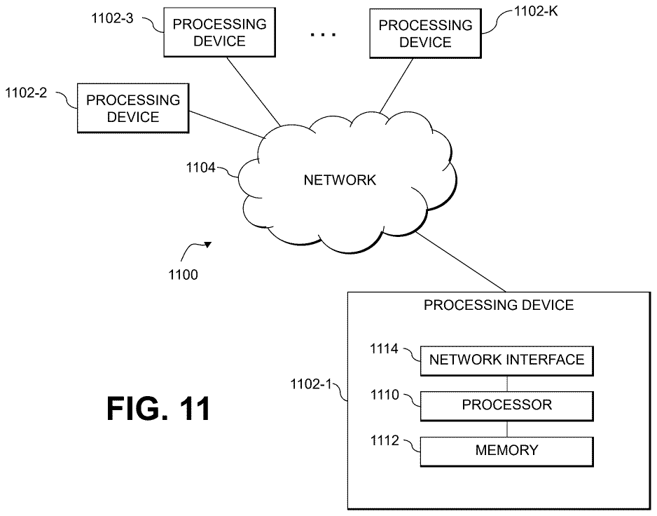

Additional examples of processing platforms utilized to implement the support platform 110 and other components of the information processing system 100 in illustrative embodiments will be described in more detail below in conjunction with FIGS. 10 and 11.

It is to be appreciated that the particular arrangement of the IT infrastructure 102, the remote monitoring equipment 103, the client devices 104, the network 106, the topology image database 108 and the support platform 110 illustrated in the FIG. 1 embodiment is presented by way of example only, and a wide variety of alternative arrangements can be used in other embodiments. For example, at least portions of the support platform 110 in some embodiments may be deployed within the monitored IT infrastructure 102, rather than separate from the IT infrastructure 102 as shown in the figure.

Also, other embodiments may include additional or alternative systems, devices and other network entities, as well as different arrangements of modules and other components. It is therefore to be appreciated that these and other features of FIG. 1 and other illustrative embodiments disclosed herein are presented by way of example only, and should not be construed as limiting in any way.

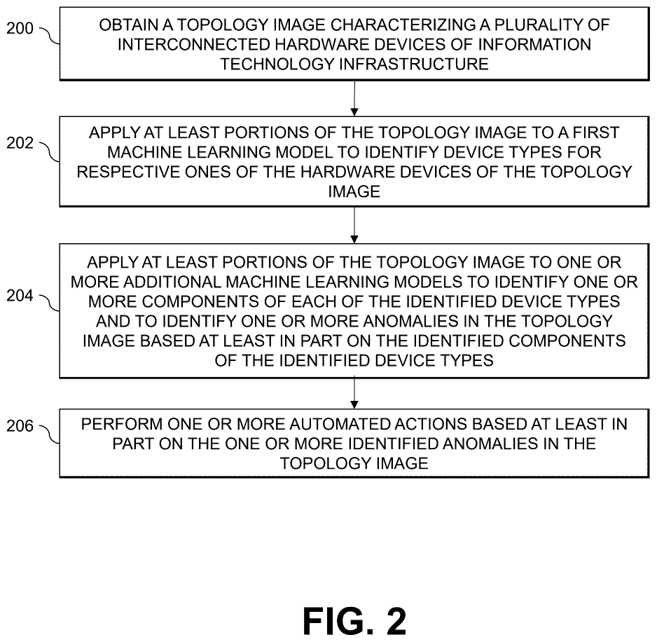

An exemplary process for machine learning-based anomaly detection and remediation in topology images of interconnected hardware devices will now be described in more detail with reference to the flow diagram of FIG. 2. It is to be understood that this particular process is only an example, and that additional or alternative processes for machine learning-based anomaly detection and remediation in topology images of interconnected hardware devices may be used in other embodiments.

In this embodiment, the example process includes steps 200 through 206. These steps are assumed to be performed by the support platform 110 utilizing the automated topology validation tool 112, including the topology image generator 114 and the machine learning-based topology image validation system 116 comprising machine learning models 118 and anomaly remediation logic 120. Similar processes may be performed utilizing alternative system components in other embodiments.

In step 200, a topology image is obtained. The topology image characterizes a plurality of interconnected hardware devices of IT infrastructure. For example, the topology image illustratively provides a visualization of a physical arrangement of multiple hardware devices such as computers, servers, switches, storage arrays and/or other processing devices, in any combination, as well as connections between those devices using cables or other types of interconnect mechanisms. In some embodiments, the topology image is generated in a support platform based at least in part on telemetry data and/or other data provided to the support platform over a network by remote monitoring equipment, such as sensors and other IoT devices, incorporated in or otherwise associated with the IT infrastructure.

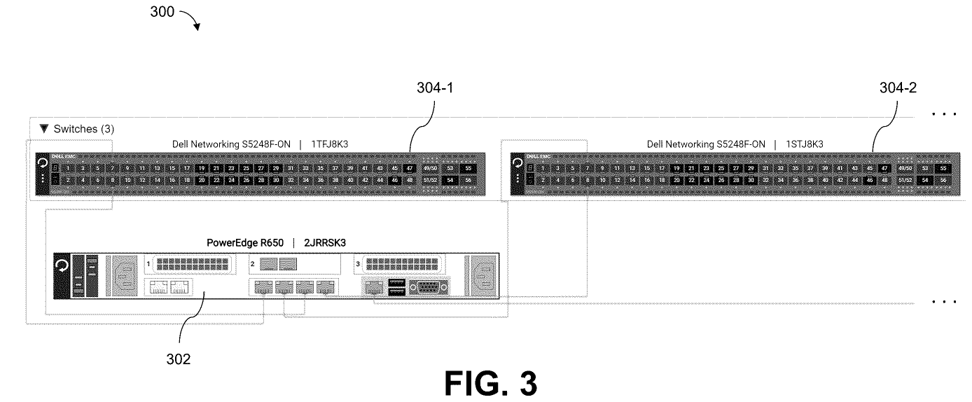

In step 202, at least portions of the topology image are applied to a first machine learning model to identify device types for respective ones of the hardware devices of the topology image. For example, the first machine learning model is illustratively trained to recognize products of a particular hardware device vendor, and can classify the products in terms of make, model, features and other aspects. The first machine learning model in some embodiments illustratively identifies a plurality of different device types that are present in the topology image, and also identifies the total number of each of the device types present in the topology image. For example, a given topology image may comprise one server of a particular type and multiple switches of a particular type, as illustrated in the example of FIG. 3.

In step 204, at least portions of the topology image are applied to one or more additional machine learning models to identify one or more components of each of the identified device types and to identify one or more anomalies in the topology image based at least in part on the identified components of the identified device types. For example, a second machine learning model can be used to identify one or more components of each of the identified device types, and a third machine learning model can be used to identify one or more anomalies in the topology image based at least in part on the identified components of the identified device types.

Examples of anomalies that may be identified in illustrative embodiments include one or more of the following:
1. Identifying at least one hardware device or component that has a first orientation in the topology image that is different than a second orientation expected based at least in part on telemetry data.
2. Identifying at least one hardware device or component that has a bounding box that overlaps with a bounding box of another hardware device or component.
3. Identifying a number of detected objects for a particular class of hardware device or component that does not match an expected number of detected objects for the particular class of hardware device or component.
4. Identifying a deviation from an interconnection rule relating to pairs of hardware devices or components.

These are just examples of anomalies, and numerous additional or alternative anomalies can be detected in a topology image in other embodiments.

In step 206, one or more automated actions are performed based at least in part on the one or more identified anomalies in the topology image. As indicated previously, such automated actions can comprise, for example, generating an updated topology image in which the one or more identified anomalies are highlighted and/or corrected, or generating in a web application a visualization of the topology image in which the one or more identified anomalies are highlighted and/or corrected.

The process comprising steps 200 through 206 can be repeated for one or more additional topology images. Additionally or alternatively, different instances of the process can operate at least in part in parallel with one another in processing different topology images, possibly relating to respective different portions of the IT infrastructure.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Additional machine learning aspects of illustrative embodiments will now be described with reference to FIGS. 3 through 9.

In some of the embodiments to be described, an example process may include the following steps:
1. Generate or otherwise obtain a topology diagram or other type of topology image.
2. Recognize the particular number and type of different hardware devices that appear in the topology image.
3. Recognize particular components within a given hardware device (e.g., a power supply, an IO card, a port of a particular type such as an Ethernet port, or another component).
4. Determine, based on the recognized components of the recognized hardware devices, whether or not the topology image includes one or more anomalies (e.g., something is drawn incorrectly, is missing, or is inconsistent with telemetry data).
5. Generate outputs including identification of errors, discrepancies or other deviations from best practices, associated recommendations, and highlighted and/or corrected topology images as needed to address any anomalies.

This process is an illustrative example of an algorithm implemented in the automated topology validation tool 112 of the support platform 110, but other algorithms could be used in other embodiments. For example, additional or alternative steps may be used, possibly in a different order, and with at least partial overlap between certain steps.

Referring now to FIG. 3, an example of a portion of a topology image 300 is shown. The topology image in this example comprises a server 302 of a particular type interconnected with a plurality of switches 304-1, 304-2, . . . of a particular type. Additional servers, switches and/or other hardware devices may be included in the topology image 300 but are not explicitly shown in this figure. The topology image 300 illustratively captures information characterizing these hardware devices, such as make, model number and/or part number. For example, the server 302 is illustratively a PowerEdge R650 server from Dell Technologies Inc. and the switches 304 are illustratively Dell Networking S5248F-ON switches, more generally referred to herein as PowerSwitch switches, also from Dell Technologies Inc. The topology image 300 also captures interconnections between these hardware components, such as interconnections between particular ports of the server 302 and particular ports of the switches 304. Again, although only a single server 302 and two switches 304 are shown in this example, the topology image 300 may comprise additional hardware devices not explicitly shown.

The topology image 300 may be rendered, for example, in topology image generator 114, responsive to receipt in support platform 110 of a service tag denoting a particular IT asset interconnected with one or more other IT assets in the IT infrastructure 102. The topology image 300 illustratively indicates interconnections between a particular hardware device and other hardware devices of the IT infrastructure 102. In some embodiments, port-to-port connections between IT assets are shown, as well as visual details representing various components of each of the IT assets. Such IT assets are examples of what are more generally referred to as “hardware devices” of the IT infrastructure 102.

Upon rendering of the topology image 300, the machine learning-based topology image validation system 116 is executed utilizing the machine learning models 118 and the anomaly remediation logic 120. This illustratively involves processing at least portions of the topology image 300 through multiple distinct ones of the machine learning models 118, to identify any errors, discrepancies or other deviations from best practices, each an example of what is more generally referred to herein as an “anomaly” in the topology image 300. It also illustratively involves generating, under control of anomaly remediation logic 120, one or more associated recommendations, and highlighted and/or corrected topology diagrams as needed to address any anomalies. The identified anomalies in some embodiments are determined based at least in part on underlying telemetry data of the topology image 300, in combination with the knowledge of the identified hardware devices and their respective components as embodied in the trained machine learning models.

Examples of anomalies that could be identified and reported in conjunction with the topology image 300 or other similar topology images include the following errors:
1. The rendering of the server is incorrectly shown as a PowerEdge R650xs, not a PowerEdge R650. The first machine learning model is trained to recognize particular device types and can therefore identify such a discrepancy.
2. The IO card in slot 2 on the server incorrectly shows only two ports, but it should show four ports.
3. Port 15 on PowerSwitch 1TFJ8K3 is shown in a particular color (e.g., blue) indicating that the port is “up” when it should instead be shown in a different color (e.g., black) to indicate that the port is “down.”
4. IO card 1 in the topology image overlaps with IO card 2, thus obscuring some of the ports on one or both of the IO cards.
5. The PowerEdge server is actually connected to four switches, not three, and therefore a switch is not being rendered in the topology image.
6. A cable is not being shown in the topology image that should connect port 1 in IO card slot 2 to Dell Switch 1TFJ8K3 port 15 as per the telemetry data.

In some embodiments, at least one updated topology image is generated, such as a revised topology image with mark-up of any identified anomalies and/or a new topology image with any anomalies corrected.

Other types of information can also be reported, including by way of example various deviations from best practices and/or associated recommendations, including one or more of the following examples:
1. A second top-of-rack (TOR) management switch could be deployed for improved performance.
2. Cable loop 3 has target or initiator ports that originate on the same controller.
3. Side A of cable loop 4 has a cable connected to a controller port of type Unknown.
4. Enclosure JBOD index 8 has multiple cables connected to the same PowerEdge controller, where JBOD denotes “just a bunch of disks.”
5. An incorrect cable type (e.g., a 25 Gbps cable) is plugged into port 4 on enclosure index 3 with logical name 5000C04F2D2D77D3F.

Again, the forgoing enumerated items are just examples, and should not be construed as limiting in any way.

As indicated above, a topology image such as topology image 300 is initially processed in a first machine learning model of the machine learning models 118 in order to identify device types for respective ones of the hardware devices of the topology image, such as the server 302 and switches 304 of the topology image 300.

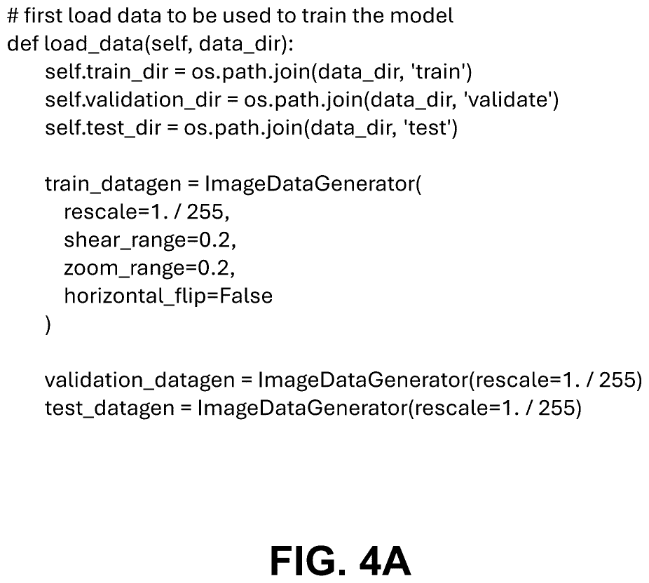

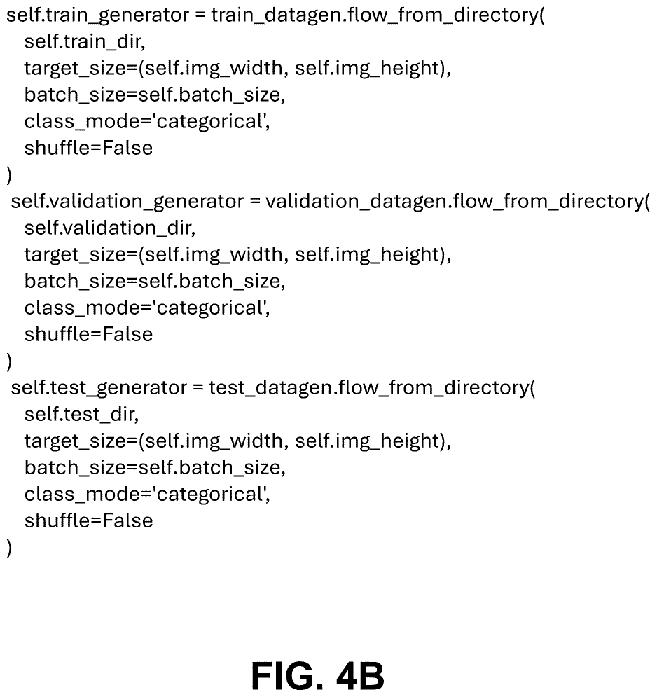

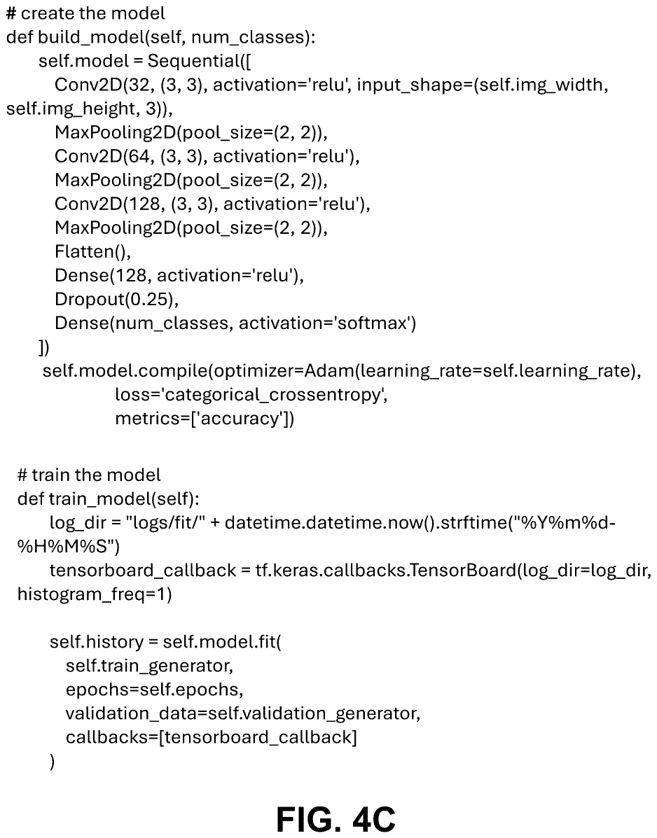

FIG. 4 shows example pseudocode for configuring and training the first machine learning model for recognizing hardware devices of different device types in an illustrative embodiment. In this embodiment, the first machine learning model is assumed to comprise a convolutional neural network (CNN), although it is to be appreciated that any of a wide variety of other types of machine learning models can be used, as well as combinations of multiple such models. The term “machine learning model” as used herein is therefore intended to be broadly construed, and in some embodiments can comprise a combination of multiple distinct machine learning models of different types. The pseudocode of FIG. 4 is generally configured to load data used to train the first machine learning model and to create and train the first machine learning model, as is more particularly shown in FIGS. 4A, 4B and 4C.

The example pseudocode of FIG. 4 and other figures herein is illustratively written in Python and is configured to utilize open-source machine learning platforms such as TensorFlow and Keras, although other model training and creation arrangements could be used. FIGS. 4A and 4B generally show pseudocode utilized to load training data and to create and train a neural network classification model, and more particularly a multi-layer CNN classifier, to classify hardware devices in a topology image. The training data illustratively comprises images of hardware devices of various types that are to be identified in topology images. The example pseudocode directs TensorFlow to create and train the above-noted first machine learning model as a multi-layer CNN classifier with parameters appropriate for the hardware device recognition task.

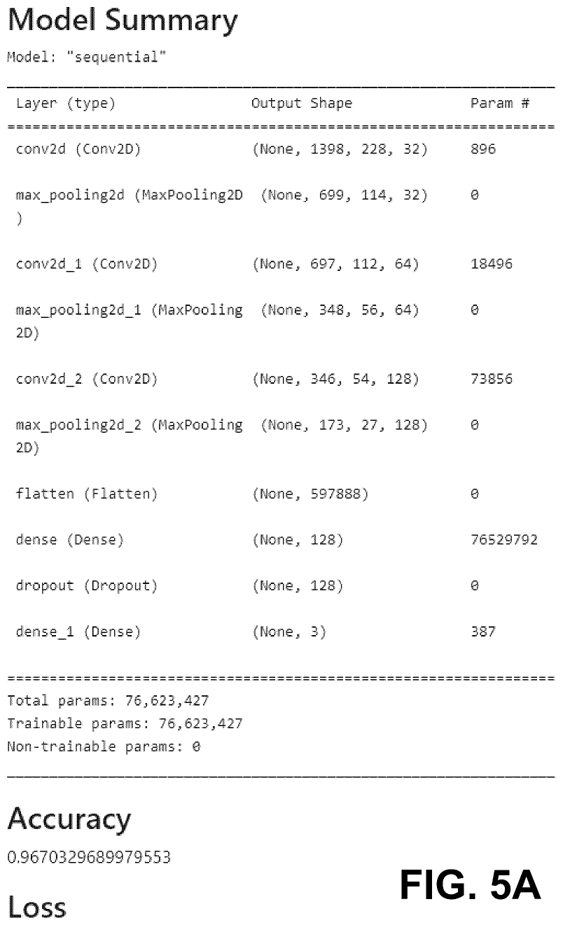

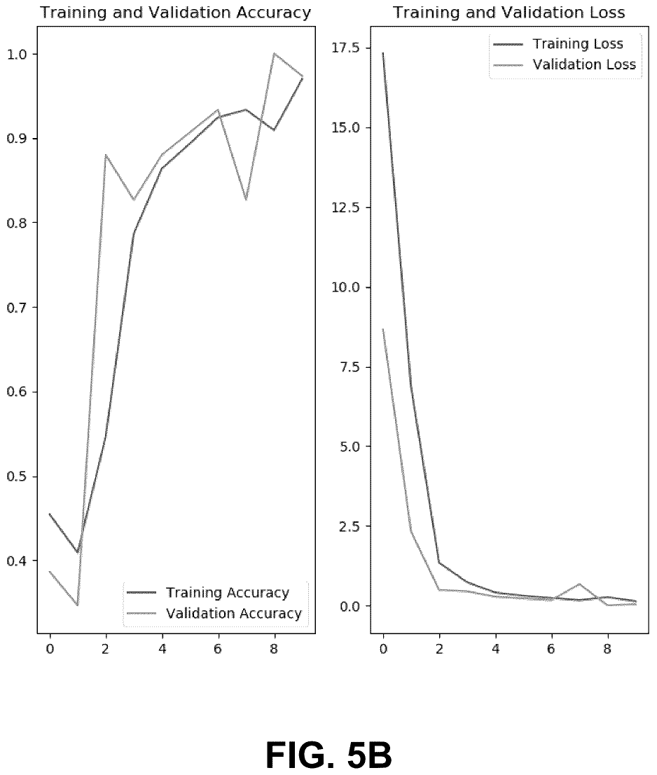

FIG. 5A shows additional details regarding example model parameters for the first machine learning model for recognizing hardware devices of different device types in an illustrative embodiment. The first machine learning model in this example has over 76.6 million trainable parameters and can achieve an accuracy of about 96.7%. Again, this is an example of a CNN model, but the particular types, sizes and configurations of layers and other model features are for purposes of illustration only and should not be viewed as limiting in any way on the scope of the present disclosure. Those skilled in the art will recognize that a wide variety of alternative machine learning models may be used in other embodiments.

Example performance plots for training and validation accuracy and training and validation loss, for the first machine learning model of FIG. 5A, are shown on the respective left and right sides of FIG. 5B. These plots illustrate percentage accuracy and loss as a function of training iterations. It is to be appreciated that such performance is merely illustrative, and other machine learning models suitable for use in illustrative embodiments herein may exhibit different performance.

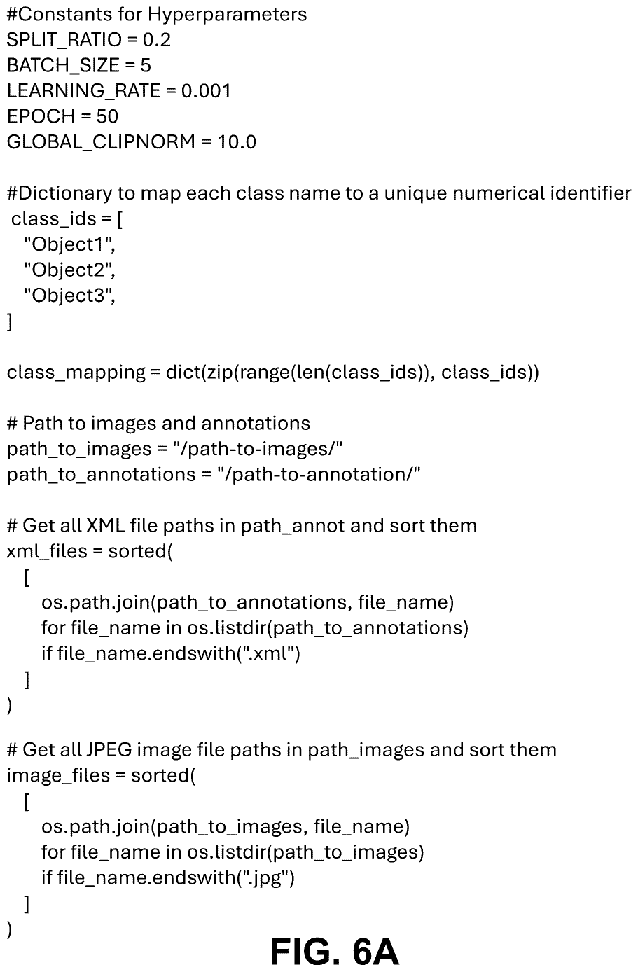

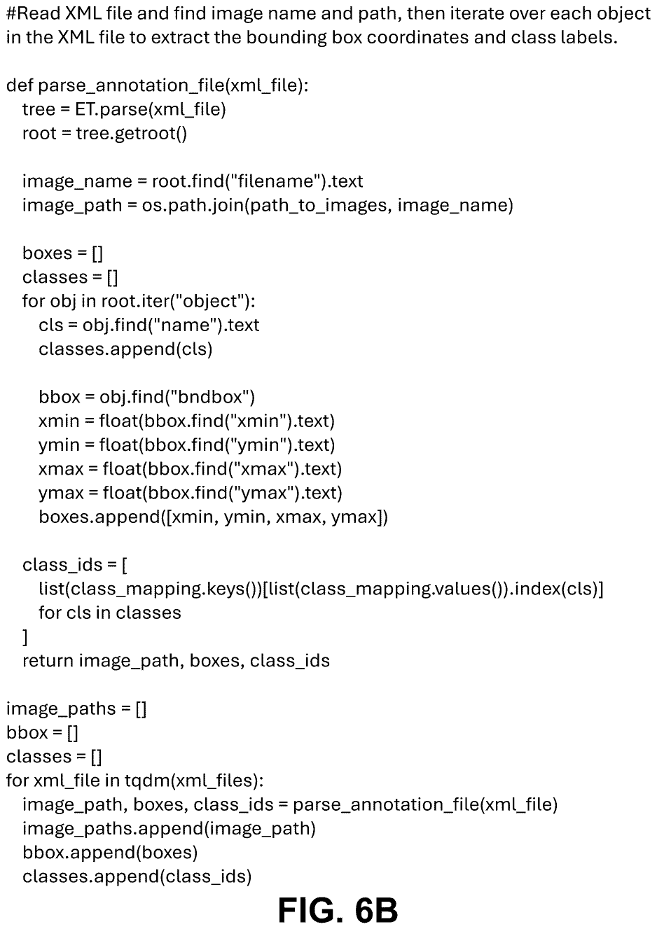

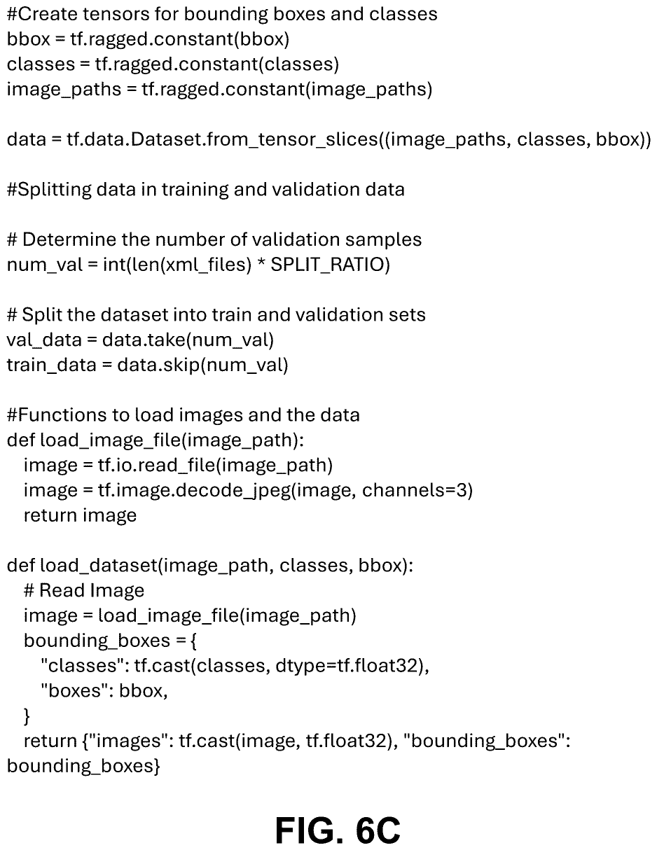

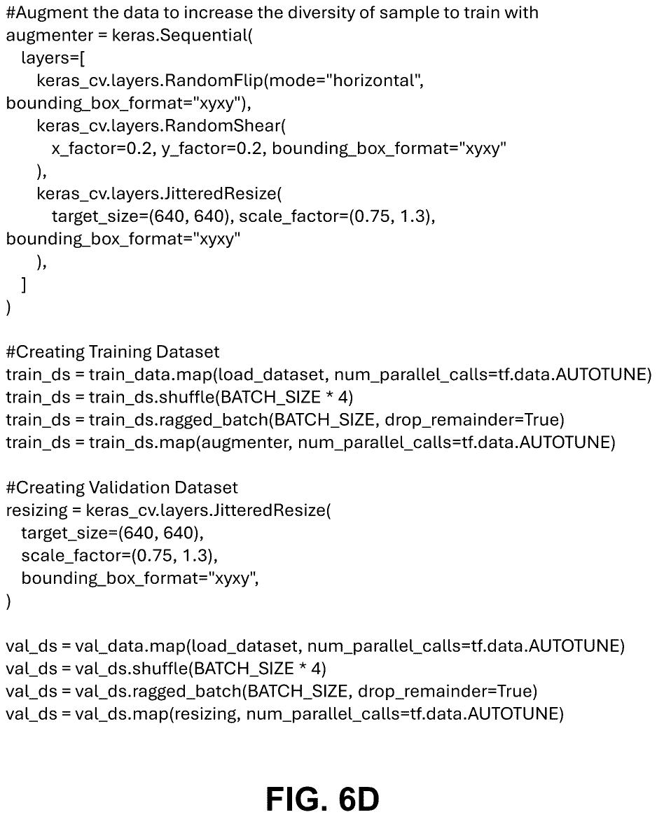

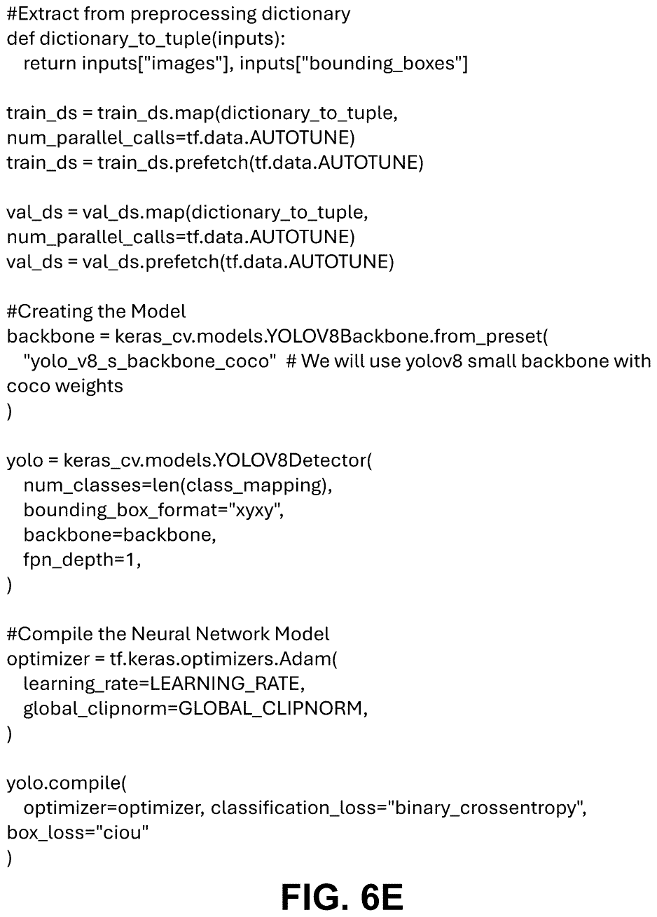

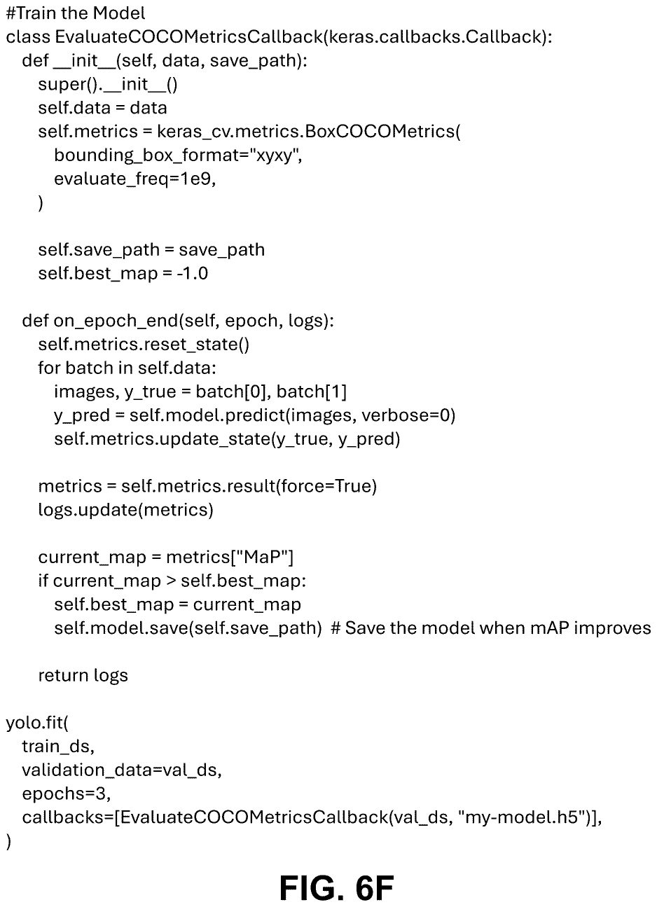

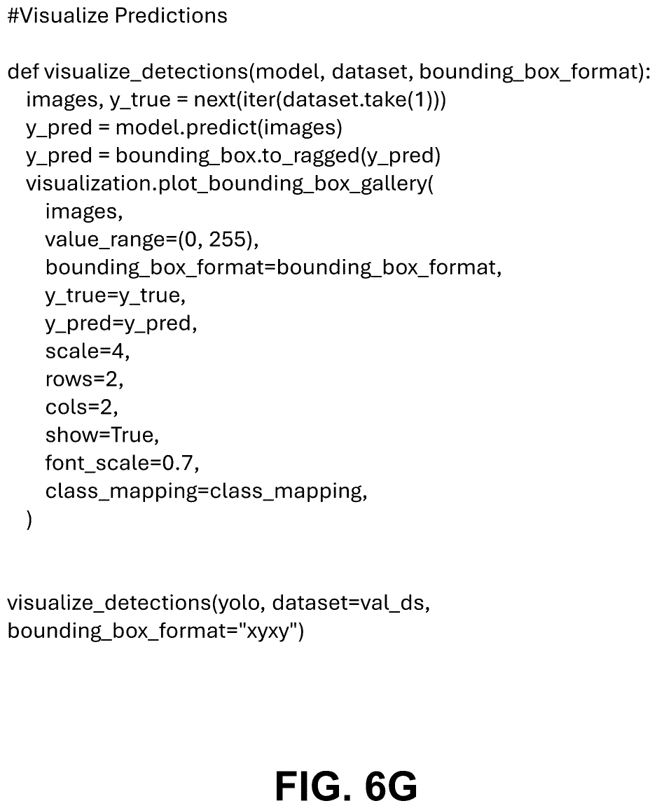

Referring now to FIG. 6, the component figures thereof show example pseudocode for utilizing a trained machine learning model to recognize hardware devices of different device types in an illustrative embodiment. This pseudocode is more particularly configured to identify the hardware devices that are present in the topology diagram, their respective device types, and the total number of hardware devices of each device type. Such information can be validated against corresponding telemetry data and/or other types of underlying data as part of a subsequent anomaly identification step, to ensure that the identified hardware devices and their respective interconnections are consistent with what is expected for that portion of the IT infrastructure. The example pseudocode as shown utilizes a You Only Look Once (YOLO) machine learning model for objection detection, but other types of machine learning models can be used for this task in other embodiments.

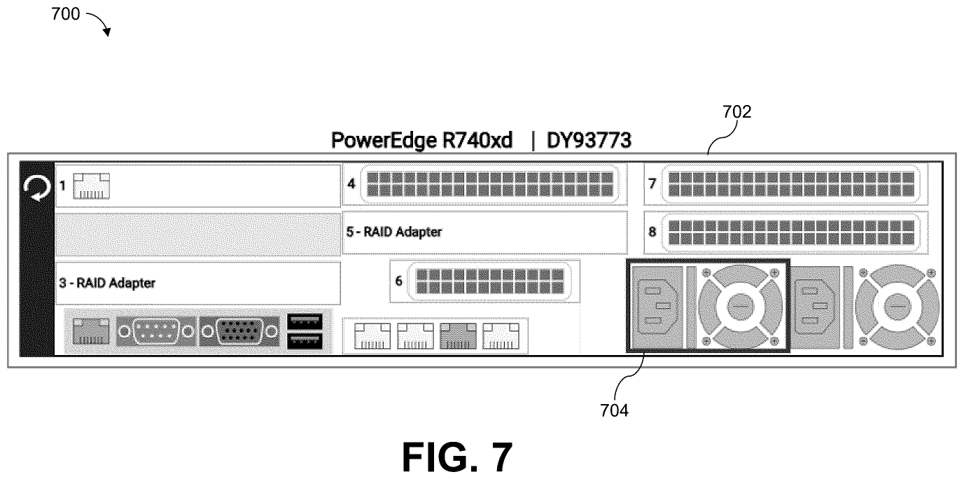

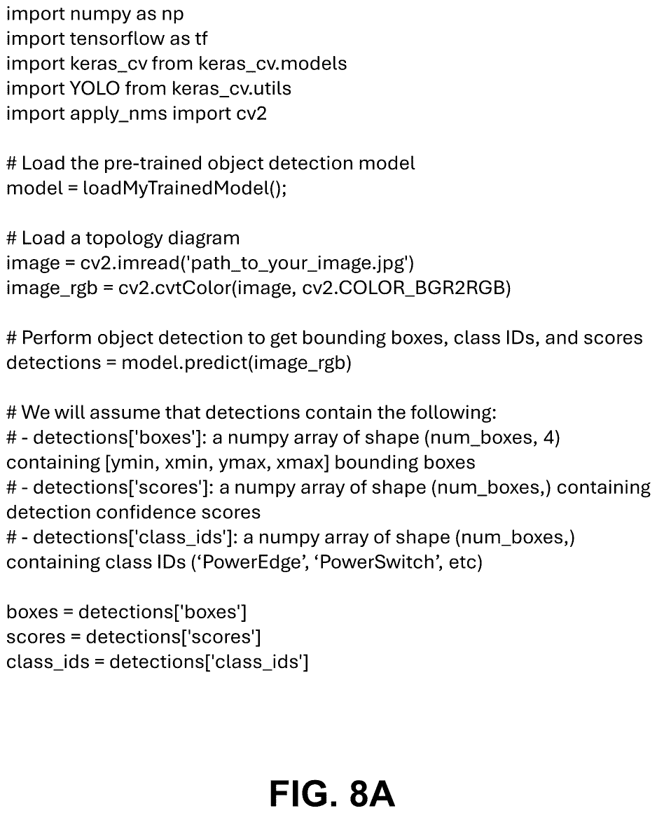

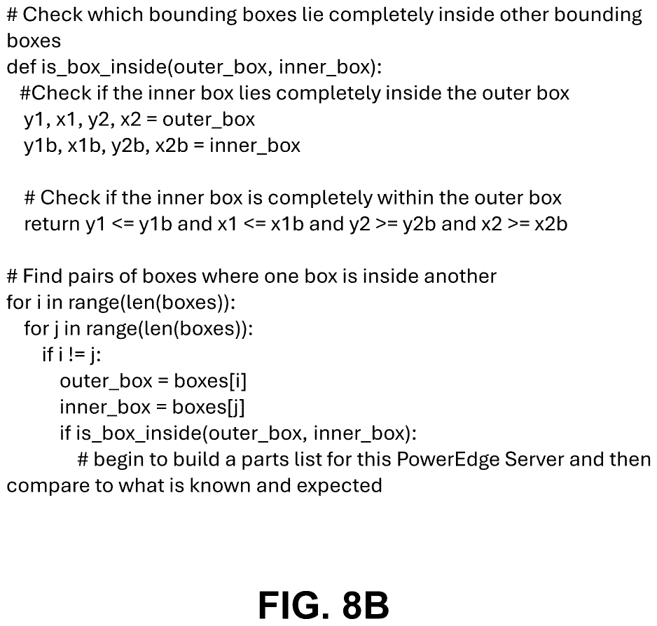

FIG. 7 shows an example of a portion of a topology image 700 comprising a server 702, illustratively a PowerEdge R740xd server, having a plurality of identifiable components including a power supply component 704 identified through machine learning-based processing in an illustrative embodiment. In this example, the server 702 is delineated by a first bounding box generated using the example machine learning model of FIG. 6. The power supply component 704 is delineated by a second bounding box within the first bounding box, generated in a manner that is shown in FIG. 8 as described below.

FIG. 8 shows example pseudocode for identifying particular components of a given hardware device of an identified device type in an illustrative embodiment, such as power supply component 704 within server 702 in the topology image 700. This example pseudocode utilizes an approach similar to that utilized in FIG. 6, but is configured to identify particular components of hardware devices of particular device types. The hardware device bounding boxes determined in conjunction with the example pseudocode of FIG. 6 are illustratively utilized in the example pseudocode of FIG. 8 to identify particular components within the hardware device bounding boxes. Such an approach is illustratively utilized to create a parts list of identified components within each identified hardware device of a particular type. This information can also be validated against corresponding telemetry data and/or other types of underlying data as part of a subsequent anomaly identification step, to ensure that the identified components for each hardware device and their respective interconnections are consistent with what is expected for that portion of the IT infrastructure.

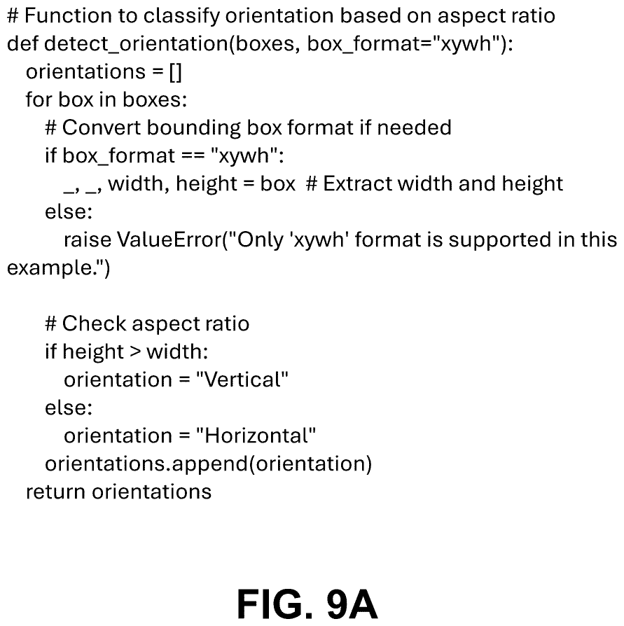

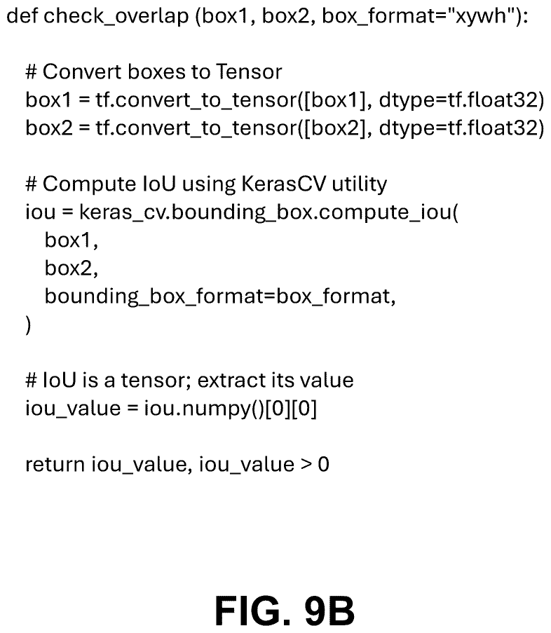

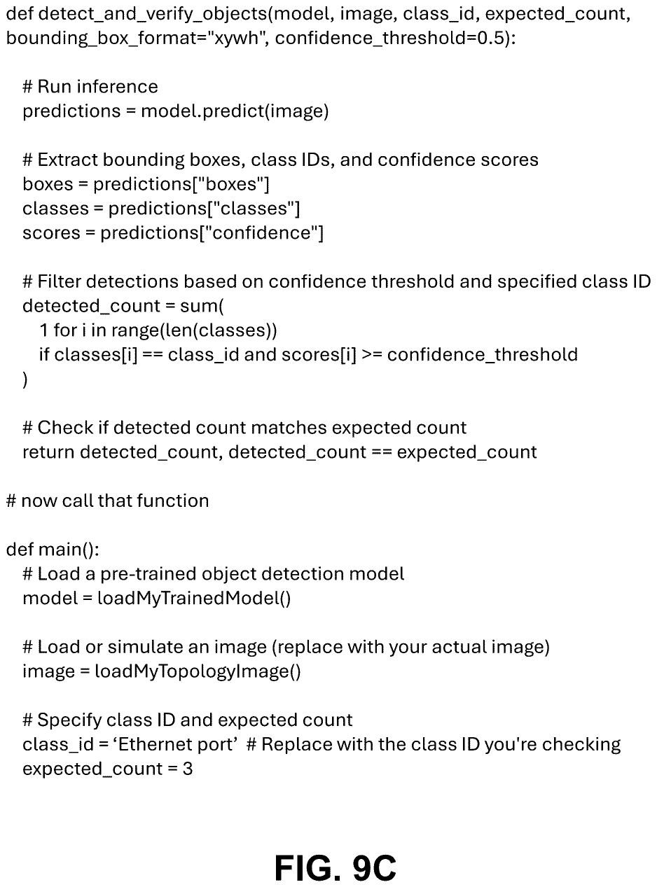

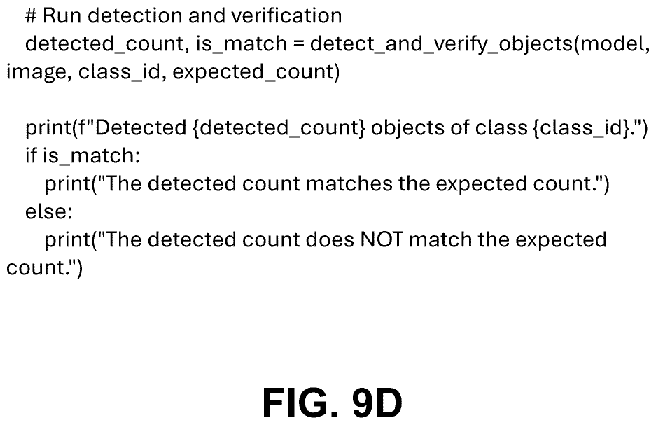

Referring now to FIG. 9, example pseudocode is shown for identifying anomalies in a topology image using identified components of hardware devices of identified device types in an illustrative embodiment. Identifying such anomalies in the FIG. 9 embodiment illustratively includes detecting when a hardware device or component is drawn incorrectly in the topology image, detecting when an expected component is missing from the topology image, or detecting when the hardware devices in the topology image are interconnected in a way that does not follow best practices. The particular types of anomalies detected by this pseudocode are just examples, and additional or alternative anomalies can be detected using one or more machine learning models in other embodiments. The term “anomaly” as used herein is therefore intended to be broadly construed.

FIG. 9A more particularly shows example pseudocode for determining whether a particular object in the topology diagram, such as a hardware device or a component of a hardware device, has a vertical orientation instead of the trained and expected horizontal orientation.

FIG. 9B more particularly shows example pseudocode for determining whether two bounding boxes for identified objects overlap, such as when two ports overlap one another, which indicates an error condition in the topology image.

FIGS. 9C and 9D more particularly show example pseudocode for determining whether a count of detected objects for a particular class (e.g., PowerEdge, PowerSwitch, power supply, IO card, port, etc.) does not match an expected count of the objects of that class from the corresponding telemetry data and/or other underlying data (e.g., JSON data).

As indicated above, other examples of topology image anomaly detection that may be implemented using the disclosed techniques include detecting when the hardware devices in the topology image are interconnected in a way that does not follow best practices. This aspect of anomaly detection can be implemented at least in part by comparing the corresponding telemetry data and/or other underlying data to a set of rules relating to optimal connectivity in a given deployment scenario. For example, if a cable is connected from a switch to PowerEdge port 1 and a rule indicates that it should go to PowerEdge port 2, then that is a best practices violation and can be flagged as such.

After one or more anomalies are identified in the topology image utilizing the techniques disclosed herein, one or more automated actions are performed based at least in part on the one or more identified anomalies in the topology image. For example, various automated actions can be performed to remediate the identified anomalies, such as generating an updated topology image in which the one or more identified anomalies are highlighted and/or corrected. As another example, a visualization of the topology image can be generated in a web application accessible via a user device, with the visualization highlighting the one or more identified anomalies. Numerous additional or alternative automated actions can be triggered utilizing outputs of machine learning-based anomaly detection in topology images as disclosed herein.

Illustrative embodiments can also be configured to process topology images that represent proposed configurations of hardware devices in a data center or other arrangement of IT infrastructure, in a design phase prior to actual physical deployment and interconnection of those hardware devices. The disclosed machine learning-based anomaly detection and remediation techniques can be adapted in a straightforward manner to process topology images in such design phases and in numerous other implementation contexts.

It is to be appreciated that the particular functionality, features and advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based anomaly detection and remediation in topology images of interconnected hardware devices will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based anomaly detection and remediation in topology images of interconnected hardware devices as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, support platforms, topology images, machine learning models, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a topology image characterizing a plurality of interconnected hardware devices of information technology infrastructure;
to apply at least portions of the topology image to a first machine learning model to identify device types for respective ones of the hardware devices of the topology image;
to apply at least portions of the topology image to one or more additional machine learning models to identify one or more components of each of the identified device types and to identify one or more anomalies in the topology image based at least in part on the identified components of the identified device types; and
to perform one or more automated actions based at least in part on the one or more identified anomalies in the topology image.

2. The apparatus of claim 1 wherein performing one or more automated actions comprises generating an updated topology image in which the one or more identified anomalies are highlighted and/or corrected.

3. The apparatus of claim 1 wherein performing one or more automated actions comprises generating in a web application a visualization of the topology image in which the one or more identified anomalies are highlighted and/or corrected.

4. The apparatus of claim 1 wherein the first machine learning model is configured to identify a total number of devices of each of the identified device types in the topology image.

5. The apparatus of claim 1 wherein the first machine learning model comprises at least one convolutional neural network (CNN).

6. The apparatus of claim 1 wherein the one or more additional machine learning models comprise:
a second machine learning model configured to identify the one or more components of each of the device types; and
a third machine learning model configured to identify the one or more anomalies in the topology image based at least in part on the identified components of the identified device types.

7. The apparatus of claim 1 wherein obtaining the topology image comprises generating the topology image based at least in part on telemetry data provided by remote monitoring equipment associated with the interconnected hardware devices of the information technology infrastructure.

8. The apparatus of claim 1 wherein identifying one or more anomalies in the topology image based at least in part on the identified components of the identified device types comprises identifying at least one hardware device or component that has a first orientation in the topology image that is different than a second orientation expected based at least in part on telemetry data.

9. The apparatus of claim 1 wherein identifying one or more anomalies in the topology image based at least in part on the identified components of the identified device types comprises identifying at least one hardware device or component that has a bounding box that overlaps with a bounding box of another hardware device or component.

10. The apparatus of claim 1 wherein identifying one or more anomalies in the topology image based at least in part on the identified components of the identified device types comprises identifying a number of detected objects for a particular class of hardware device or component that does not match an expected number of detected objects for the particular class of hardware device or component.

11. The apparatus of claim 1 wherein identifying one or more anomalies in the topology image based at least in part on the identified components of the identified device types comprises identifying a deviation from an interconnection rule relating to pairs of hardware devices or components.

12. A computer program product comprising a non-transitory processor-readable storage medium having stored therein program code of one or more software programs, wherein the program code when executed by at least one processing device causes the at least one processing device:
to obtain a topology image characterizing a plurality of interconnected hardware devices of information technology infrastructure;
to apply at least portions of the topology image to a first machine learning model to identify device types for respective ones of the hardware devices of the topology image;
to apply at least portions of the topology image to one or more additional machine learning models to identify one or more components of each of the identified device types and to identify one or more anomalies in the topology image based at least in part on the identified components of the identified device types; and
to perform one or more automated actions based at least in part on the one or more identified anomalies in the topology image.

13. The computer program product of claim 12 wherein the one or more additional machine learning models comprise:
a second machine learning model configured to identify the one or more components of each of the device types; and
a third machine learning model configured to identify the one or more anomalies in the topology image based at least in part on the identified components of the identified device types.

14. The computer program product of claim 12 wherein obtaining the topology image comprises generating the topology image based at least in part on telemetry data provided by remote monitoring equipment associated with the interconnected hardware devices of the information technology infrastructure.

15. The computer program product of claim 12 wherein identifying one or more anomalies in the topology image based at least in part on the identified components of the identified device types comprises identifying a number of detected objects for a particular class of hardware device or component that does not match an expected number of detected objects for the particular class of hardware device or component.

16. A method comprising:
obtaining a topology image characterizing a plurality of interconnected hardware devices of information technology infrastructure;
applying at least portions of the topology image to a first machine learning model to identify device types for respective ones of the hardware devices of the topology image;
applying at least portions of the topology image to one or more additional machine learning models to identify one or more components of each of the identified device types and to identify one or more anomalies in the topology image based at least in part on the identified components of the identified device types; and
performing one or more automated actions based at least in part on the one or more identified anomalies in the topology image;
wherein the method is performed by at least one processing device comprising a processor coupled to a memory.

17. The method of claim 16 wherein the one or more additional machine learning models comprise:
a second machine learning model configured to identify the one or more components of each of the device types; and
a third machine learning model configured to identify the one or more anomalies in the topology image based at least in part on the identified components of the identified device types.

18. The method of claim 16 wherein obtaining the topology image comprises generating the topology image based at least in part on telemetry data provided by remote monitoring equipment associated with the interconnected hardware devices of the information technology infrastructure.

19. The method of claim 16 wherein identifying one or more anomalies in the topology image based at least in part on the identified components of the identified device types comprises identifying a number of detected objects for a particular class of hardware device or component that does not match an expected number of detected objects for the particular class of hardware device or component.

20. The method of claim 16 wherein identifying one or more anomalies in the topology image based at least in part on the identified components of the identified device types comprises identifying a deviation from an interconnection rule relating to pairs of hardware devices or components.
